(19) United States
(12) Patent Application Publication
(10) Pub. No.: US 2005/0120809 A1
(43) Pub. Date: Jun. 9, 2005

(54) Robotic force sensing device

(76) Inventor: John E. Ramming, Woodland, CA (US)

Correspondence Address: BURNS DOANE SWECKER & MATHIS L L P, POST OFFICE BOX 1404, ALEXANDRIA, VA, 22313-1404, US

(21) Appl. No.: 10/732,060

(22) Filed: Dec. 9, 2003

(51) Int. Cl. G01L 1/22

(52) U.S. Cl. 73/862.044

(57) ABSTRACT

The present invention to provides a force measuring device suitable for use in robotic applications, having a high degree of sensitivity, stiffness, compact size, and reasonable cost. The invention includes an inner plate, surrounded by an outer plate. The inner and outer plates are integrally connected by a plurality of strain sensing flexures, generally in the form of strain rings, on which strain sensing devices are mounted. Local loads measured by the strain rings are converted to global loads, which describe forces present between the inner and outer plates.

### BACKGROUND OF THE INVENTION

Force measuring transducers are well known to those in the art. Generally, they are composed of an inner component surrounded by an outer component. Strain measuring flexures, usually deformable beams, link the inner and outer components and deflect under forces being transmitted from the two components. Strain sensing devices are placed on the deformable flexures to measure the deflection of the beams under the force loads. Most of the prior art devices suitable for measuring torque and forces in automobile wheels and other industrial applications, for example, are relatively large and bulky, and lack the sensitivity to measure smaller force loads. Generally, the aforementioned devices are too large and bulky to find use in miniaturized robotics applications.

In the field of robotics, the measurement of forces in the robot appendages is becoming an essential requirement. Bipedal robots, such as those manufactured by the Honda Corporation (marketed under the name of Asimo), or Sony Corporation's SDR-4x, need very sensitive force measurement transducers incorporated into the wrists and feet to aid in balance and touch functions. Such force measuring devices require a compact size, high sensitivity, and high stiffness. These are requirements that are not met by the conventional force measuring technology of the prior art.

Thus, it would be desirable to provide a force measurement device suitable for use in robotic applications, having a high degree of sensitivity, stiffness, compact size, and reasonable cost.

### SUMMARY OF THE INVENTION

It is an object of the present invention to provide a force measuring device suitable for use in robotic applications, having a high degree of sensitivity, stiffness, compact size, and reasonable cost. In one embodiment of the present invention, a force measuring device having three integral components includes a first component comprising a rigid inner plate, a second component comprising a rigid outer plate surrounding the inner plate and oriented generally parallel to the inner plate, and a third component comprising a plurality of flexure links disposed between the inner plate and the outer plate, integrally connecting the inner plate to the outer plate, the flexure links comprising strain rings operative to measure forces between the inner plate and the outer plate. In another embodiment of the present invention, a force measuring device having three integral components includes a first component comprising a rigid inner plate, a second component comprising a rigid outer plate surrounding the inner plate and oriented generally parallel to the inner plate, and a third component comprising a plurality of strain rings disposed between the inner plate and the outer plate, integrally connecting the inner plate to the outer plate, and operative to measure forces between the inner plate and the outer plate. The strain rings include a generally annular shaped top surface, a generally annular shaped bottom surface, and an inner surface extending between the top and the bottom surfaces, the inner surface defining a right circular cylinder. An outer surface extends between the top and bottom surfaces, the outer surface having a generally cylindrical shape. The strain rings further include a first interconnecting segment extending over a first portion of the outer surface, integrally connecting said strain ring with the inner plate, and a second interconnecting segment extending over a second portion of said outer surface, integrally connecting the strain ring with the outer plate.

In another embodiment of the present invention, a force measuring device having three integral components includes a first component comprising a rigid inner plate, a second component comprising a rigid outer plate surrounding the inner plate and oriented generally parallel to the inner plate, and a third component comprising a plurality of strain rings disposed between the inner plate and the outer plate, integrally connecting the inner plate to the outer plate, and operative to measure forces between the inner plate and the outer plate. The strain rings include a generally annular shaped top surface, a generally annular shaped bottom surface, and an inner surface extending between the top and the bottom surfaces, the inner surface defining a right circular cylinder. An outer surface extends between the top and bottom surfaces, the outer surface having a generally cylindrical shape. The strain rings further include a first interconnecting segment extending over a first portion of the outer surface, integrally connecting said strain ring with the inner plate, and a second interconnecting segment extending over a second portion of said outer surface, integrally connecting the strain ring with the outer plate. At least one strain measuring device is attached to the inner surface.

In another embodiment of the present invention, a force measuring device having three integral components includes a first component comprising a rigid inner plate, a second component comprising a rigid outer plate surrounding the inner plate and oriented generally parallel to the inner plate, and a third component comprising a plurality of strain rings disposed between the inner plate and the outer plate, integrally connecting the inner plate to the outer plate, and operative to measure forces between the inner plate and the outer plate. The strain rings include a generally annular shaped top surface, a generally annular shaped bottom surface, and an inner surface extending between the top and the bottom surfaces, the inner surface defining a right circular cylinder. An outer surface extends between the top and bottom surfaces, the outer surface having a generally cylindrical shape. The strain rings further include a first interconnecting segment extending over a first portion of the outer surface, integrally connecting said strain ring with the inner plate, and a second interconnecting segment extending over a second portion of said outer surface, integrally connecting the strain ring with the outer plate. At least one strain measuring device is attached to the inner surface and to the top surface.

In another embodiment of the present invention, a force measuring device having three integral components includes a first component comprising a rigid inner plate, a second component comprising a rigid outer plate surrounding the inner plate and oriented generally parallel to the inner plate, and a third component comprising a plurality of strain rings disposed between the inner plate and the outer plate, integrally connecting the inner plate to the outer plate, and operative to measure forces between the inner plate and the outer plate. The strain rings include a generally annular shaped top surface, a generally annular shaped bottom surface, and an inner surface extending between the top and the bottom surfaces, the inner surface defining a right circular cylinder. An outer surface extends between the top and bottom surfaces, the outer surface having a generally cylindrical shape. The strain rings further include a first interconnecting segment extending over a first portion of the outer surface, integrally connecting said strain ring with the inner plate, and a second interconnecting segment extending over a second portion of said outer surface, integrally connecting the strain ring with the outer plate. At least one strain measuring device is attached to the inner surface and to the bottom surface.

### BRIEF DESCRIPTION OF THE DRAWINGS

The present invention will be better understood when consideration is given to the following detailed description thereof. Such description makes reference to the annexed drawings, wherein:

FIG. 1A is a plan view of a force sensing device having four equally spaced strain rings in a circular symmetry according to an embodiment of the present invention;

FIG. 1B is a perspective view of the embodiment of FIG. 1A;

FIG. 2A is a plan view of a force sensing device having three equally spaced strain rings in a circular symmetry according to an embodiment of the present invention;

FIG. 2B is a perspective view of the embodiment of FIG. 2A;

FIG. 3A is a plan view of a force sensing device having four equally spaced strain rings in a square symmetry according to an embodiment of the present invention;

FIG. 3B is a perspective view of the embodiment of FIG. 3A;

FIG. 4A is a plan view of a force sensing device for robot applications according to an embodiment of the present invention;

FIG. 4B is a perspective view of the embodiment of FIG. 4A;

FIG. 5 is a plan view of a force sensing device relative to external forces applied to the sensing device according to an embodiment of the present invention;

FIG. 6 is a partial section view of a strain ring according to an embodiment of the present invention; and,

FIG. 7 is a partial section view of a strain ring showing the positions of sensing elements according to an embodiment of the present invention.

### DETAILED DESCRIPTION OF THE PREFERRED EMBODIMENTS

In the following description, the term force sensing device will signify the complete assembly, which generally includes three main components: an inner plate, an outer plate, and a plurality of flexures connecting the inner and outer plates. In the embodiments described in the present invention, the flexures are generally strain rings, onto whose surfaces a plurality of strain sensing electronic devices are placed. The strain rings provide a force sensing flexure element of high stiffness and high sensitivity, while allowing a compact design. It is generally desirable to have all of the three basic components (inner plate, outer plate, and strain rings) fabricated from a single piece of starting material, which can reduce fabrication costs and assure defect free operation. It is possible, however, to join the three main components with fasteners, adhesives, solder or welding, assuming that the joining technique does not compromise the force measurements being made. If such techniques are used, the bond created between the components must be much stronger than the forces being measured, so that no additional deflection is introduced into the structure between the bonded parts.

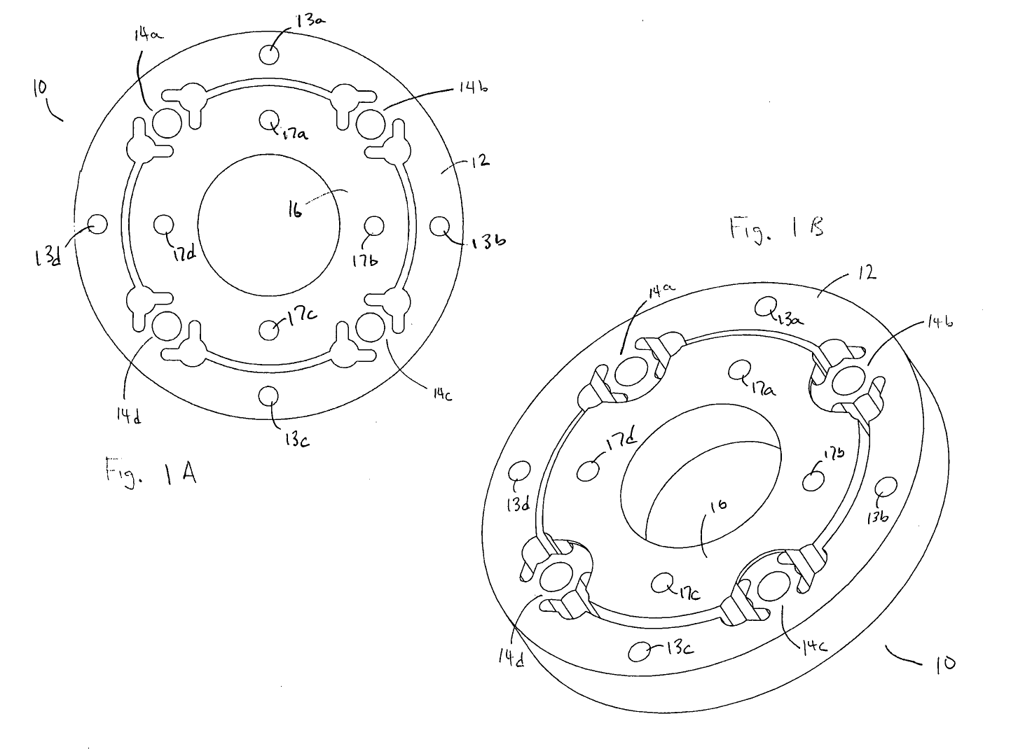

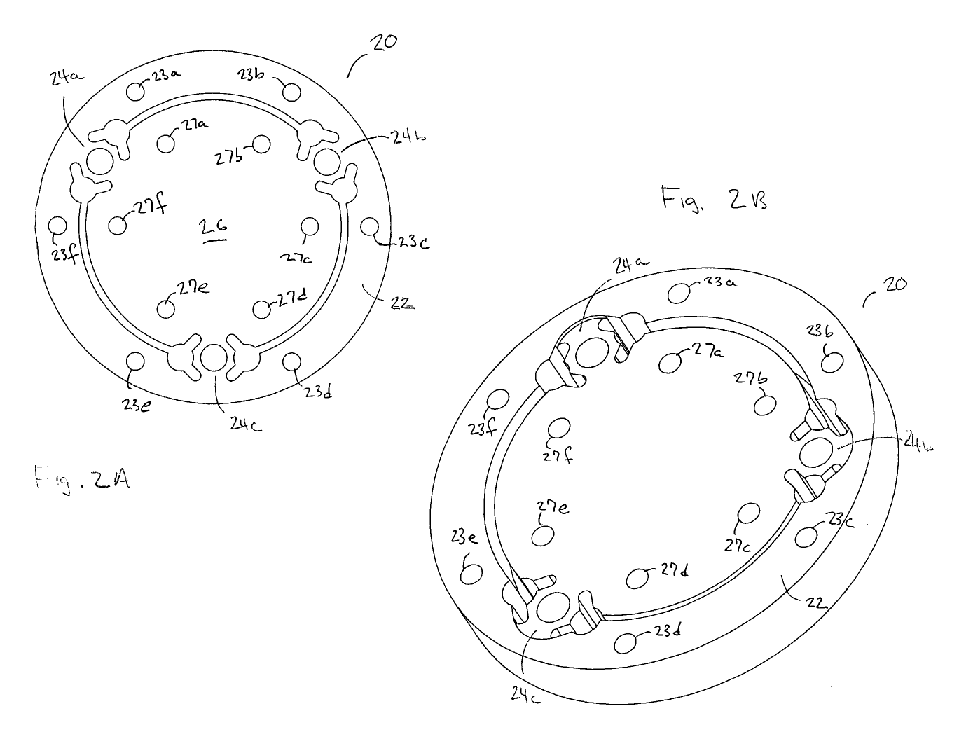

FIG. 1A is a plan view of a force sensing device 10 having four equally spaced strain rings 14 in a circular symmetry according to an embodiment of the present invention. Force sensing device 10 is composed of three main components: an outer circular shaped plate 12, an inner circular plate 16, and strain rings 14a-d integral to and connecting inner and outer plates 12 and 16. Plates 12 and 16 are generally aligned to be parallel with each other. Strain sensing devices (not shown) are mounted on surfaces of the strain rings 14a-d. External attachment to the outer plate 12 may be made via holes 13a-d. External attachment to the inner plate 16 may be made via holes 17a-d. Attachment may be made through any convenient attachment means (such as bolts, screws, pins, inserts, etc) know to those skilled in the art. The embodiment 10 may be used, for example, in a robot application to measure forces between an end effector (or mechanical “hand”) and a wrist. The wrist may be attached to the outer plate 12, and the end effector to the inner plate 16. Or vise versa. Forces transmitted from the hand to the wrist, or wrist to the hand, can be measured by device 10 connecting them. This function can be of paramount importance where a robotic system interacts with a human being, since the application of too much force can be disastrous.

FIG. 1B is a perspective view of the embodiment of FIG. 1A.

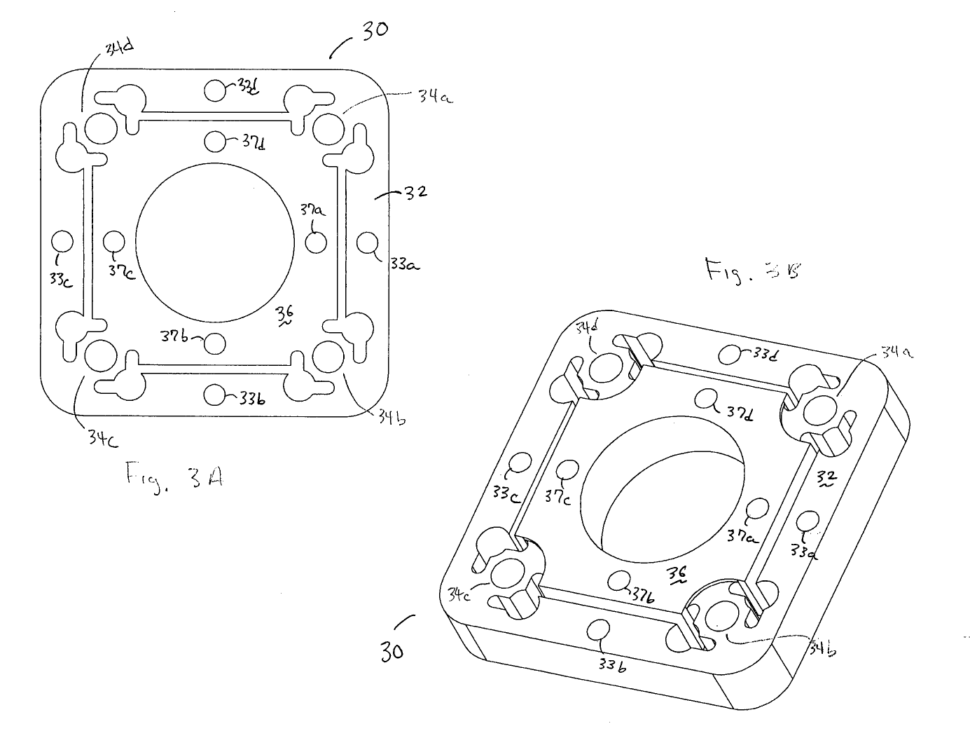

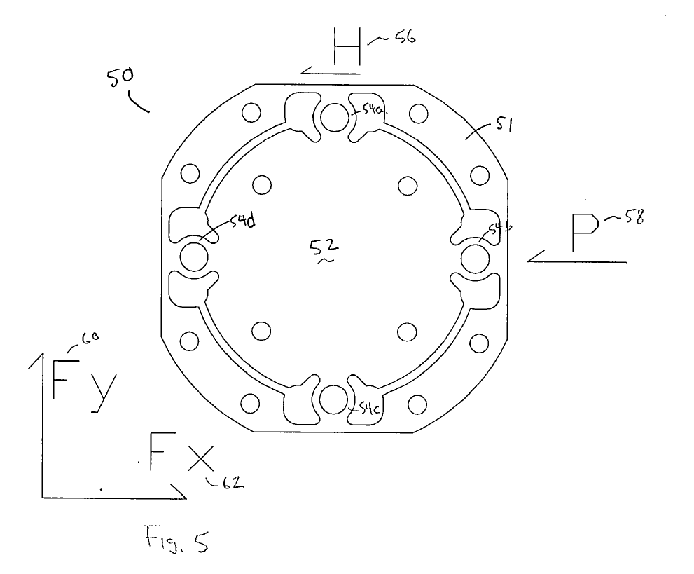

FIG. 2A is a plan view of a force sensing device having three equally spaced strain rings in a circular symmetry according to an embodiment of the present invention. Force sensing device 20 is composed of three main components: an outer circular shaped plate 22, an inner circular plate 26, and strain rings 24a-c integral to and connecting inner and outer plates 22 and 26. Plates 22 and 26 are generally aligned to be parallel with each other. Strain sensing devices (not shown) are mounted on surfaces of the strain rings 24a-c. External attachment to the outer plate 22 may be made via holes 23a-f. External attachment to the inner plate 26 may be made via holes 27a-f. Attachment may be made through any convenient attachment means (such as bolts, screws, pins, inserts, etc) know to those skilled in the art. This embodiment 20 may be used in applications similar to that described above for force sensing device 10. FIG. 2B is a perspective view of the embodiment of FIG. 2A. Both force sensing devices 10 and 20 can be utilized to measure all force loads of interest. Embodiments with three strain rings (such as device 20) have a lower cost due to having fewer strain sensing electronic devices. Embodiments with four strain rings (such as device 10) have the advantage of separating orthogonal forces loads due to orientation, thus making data evaluation more direct and improving accuracy. In some geometries, such as the foot geometry described below in FIGS. 4A/4B, four strain rings fit the structure better in that the loads through each strain ring are better balanced.

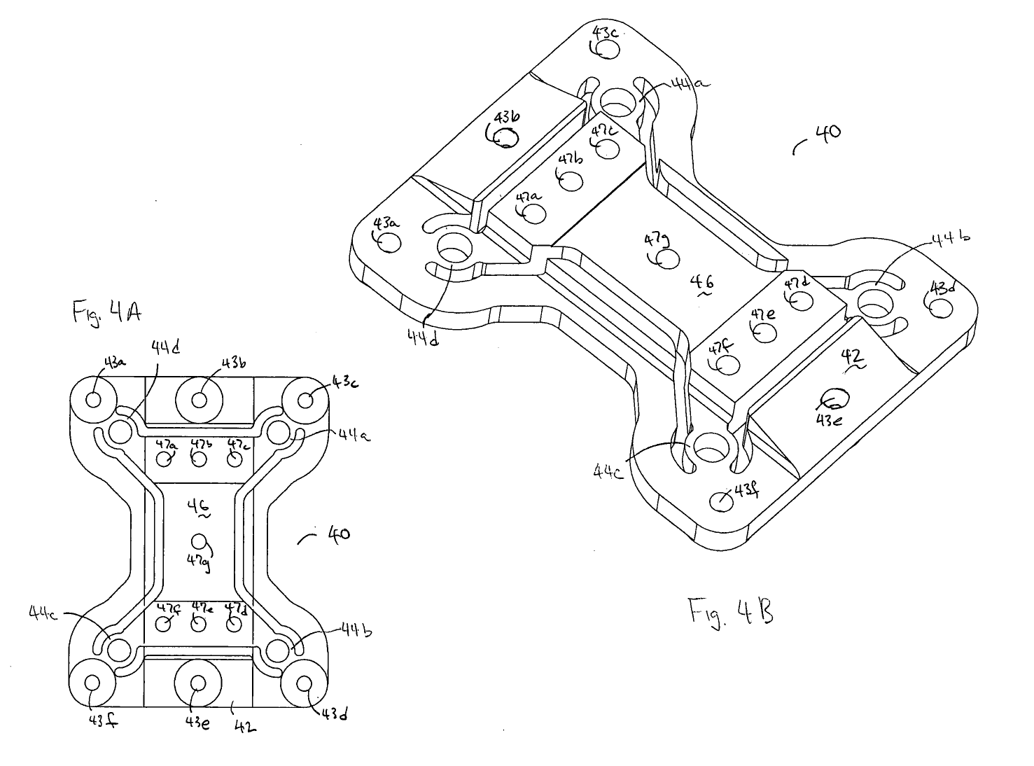

FIG. 3A is a plan view of a force sensing device 30 having four equally spaced strain rings 34a-d, in a rectangular symmetry according to an embodiment of the present invention. Force sensing device 30 is composed of three main components: an outer rectangular shaped plate 32, an inner rectangular plate 36, and strain rings 34a-d integral to and connecting the inner and outer plates 32 and 36. Plates 32 and 36 are generally aligned to be parallel with each other. Strain sensing devices (not shown) are mounted on surfaces of the strain rings 34a-d. External attachment to the outer plate 32 may be made via holes 33a-d. External attachment to the inner plate 36 may be made via holes 37a-d. Attachment may be made through any convenient attachment means (such as bolts, screws, pins, inserts, etc) know to those skilled in the art. FIG. 3B is a perspective view of the embodiment of FIG. 3A.

FIG. 4A is a plan view of a force sensing device 40 for robot applications according to an embodiment of the present invention. The specific shape illustrated may be used, for example, in a robot foot application. Force sensing device 40 is composed of three main components: an outer plate 42, an inner plate 46, and strain rings 44a-d integral to and connecting the inner and outer plates 42 and 46. Plates 42 and 46 are generally aligned to be parallel with each other. Strain sensing devices (not shown) are mounted on surfaces of the strain rings 44a-d. External attachment to the outer plate 42 may be made via holes 43a-f. External attachment to the inner plate 46 may be made via holes 47a-f. Attachment may be made through any convenient attachment means (such as bolts, screws, pins, inserts, etc) know to those skilled in the art. FIG. 4B is a perspective view of the embodiment of FIG. 4A.

FIG. 5 is a plan view of a force sensing device 50 relative to external forces applied to the sensing device according to an embodiment of the present invention. The force sensing device 50 is capable of measuring forces being transmitted from inner plate 52 through to outer plate 51 (and vise versa). These forces are generally referred to as global forces, which can be represented by Cartesian coordinate system Fx (ref 62), Fy (ref 60) and Fz (extending out of the plane of the paper, not shown). Global forces may also include moments Mx, My, and Mz (not shown). Global forces are measured indirectly by the strain rings 54a-d, which are designed so that the global forces Fx, Fy, Fz, Mx, My, and Mz can be derived from local loads measured directly by the strain rings. These local loads are generally a horizontal load H (ref 56), a vertical (shear) load oriented 6ut of the plane of the paper and centered within the strain ring 54, and a twisting load oriented along an axis connecting the two strain ring attachment points connecting the strain rings 54a-d to the inner plate 52 to the outer plate 51. Strain sensing gauges are placed on strain rings 54a-d in locations to minimize (or eliminate) the impact of a compressive force P (ref 58), which is directed along the axis connecting the two strain ring attachment points. The global forces are computed from the geometry of the various strain ring locations combined with the local forces measured at each strain ring, using techniques known by those skilled in the art. For example, a simple Global force Fx (positive to the right) would result in a negative H force at strain ring 54a, an equal positive H force at strain ring 54c, and no forces measured at strain rings 54b and 54d. In another example, a global force Mz (a moment force around the Z axis) would result in equal local H forces of the same magnitude and sign at each of the four strain rings 54a-d. In a third example, a global moment force My would produce local twisting loads, of opposite sign, at strain rings 54a and 54c, and vertical shear loads, of opposite sign, at strain rings 54b and 54d. In a fourth example, a global force Fz would produce equal local vertical (shear) load forces at all four strain rings oriented in the same direction as Fz. In a similar manner, global forces can be resolved from local forces for the three strain ring embodiment shown in FIGS. 2A and 2B.

FIG. 6 is a partial section view of a strain ring according to an embodiment of the present invention. The strain ring is generally the shape of a hollow cylinder, having an outer diameter 63, and an inner diameter 61. Preferably, the strain ring is a hollow right circular cylinder. The top surface 76 is generally of an annular shape, as is the bottom surface (not shown). Inner surface 72 is generally cylindrical in shape, preferably defining a right circular cylinder of diameter 61. Inner surface 72 extends from top surface 76 to the bottom surface. The height of the strain ring, which is the distance between the top and bottom surfaces, is generally less than or equal to the thickness of the outer plate 60 or inner plate 62. Preferably, the height of the strain ring is less than or equal to the thinner of the two plates 60 and 62. A first interconnecting segment 66 extends from the outer diameter of the strain ring at dashed line 70, merging into the structure of inner plate 62, integrally connecting the strain ring to the inner plate 62. A second interconnecting segment 64 extends from the outer diameter of the strain ring at dashed line 68, merging into the structure of outer plate 60, integrally connecting the strain ring to the outer plate 60. An outer surface 74 is generally cylindrical in shape, and extends from interconnecting regions 64 an 66 at an outer diameter 63, between top and bottom surfaces.

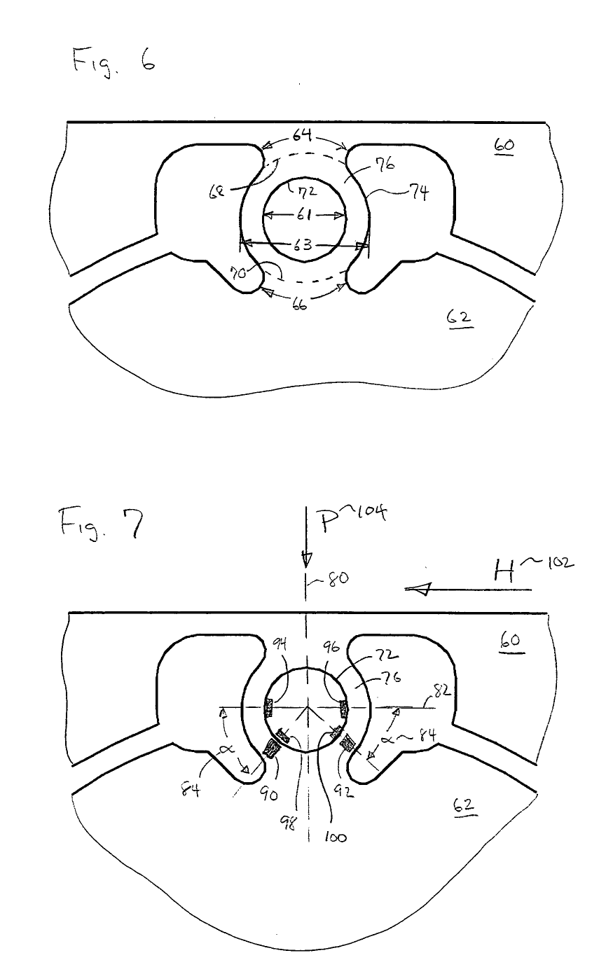

FIG. 7 is a partial section view of a strain ring showing the positions of sensing elements according to an embodiment of the present invention. Strain sensing devices, preferably strain gauges, are mounted on various surfaces of the strain ring to measure local loads. As previously mentioned, the global loads are then computed from the local load information provided by all the strain rings connecting the inner and outer plates of the force measuring device. The location of the strain gauges may be clarified by reference to a set of orthogonal axis 80 and 82, whose intersection is located at the center of circle defined by the inner diameter 61. For measuring the H load 102, at least one strain gauge is placed on the inner surface 72 at the locations indicated by ref 98 or ref 100. Preferably, bending type guages at both locations 98 and 100 are used. Alternatively, four bending type gauges can be used, one orthogonally oriented pair at position 98 and one orthogonally oriented pair at position 100. Since bending gauges have a preferred direction of maximum sensitivity, an orthogaonally oriented pair means two bending gauges mounted in close proximity to each other, but having their preferred directions of highest sensitivity at right angles to each other. The orthogonally oriented pairs are also known as Poisson's gauges and can improve the strength of the measurement by about 30%. Gauge positions 98 and 100 are located at an angular position alpha 84, measured from horizontal axis 82. Alpha is between 40 to 50 degrees, preferably 45 degrees. Strain gauges located at 98 and 100 have a minimal sensitivity to P load 104, which can be easily calibrated out in use. For measuring load V (not shown), shear type strain gauges may be located at positions 94 and 96 on the inner surface 72 of the strain ring. At least one gauge is required, but preferably two are used. Alternatively, four gauges in a Poisson's configuration may also be utilized.

In another embodiment of the present invention, the V load is measured by placing bending gauges on the top surface 76 at locations 90 and 92. Alternatively, the gauges may be placed on the bottom surface at corresponding positions (not shown). Between 1 and four gauges may be used, as described above. Gauge positions 90 and 92 are located at an angular position alpha 84, measured from horizontal axis 82. Alpha is between 40 to 50 degrees, preferably 45 degrees. The H load is measured by placing gauges at positions 98 and 100, as explained in detail above.

While various embodiments have been described above, it should be understood that they have been presented by way of example only, and not limitation. Thus, the breadth and scope of an embodiment of the present invention should not be limited by any of the above described exemplary embodiments, but should be defined only in accordance with the following claims and their equivalents.

1. A force measuring device having three integral components, comprising:
a first component including a rigid inner plate;
a second component including a rigid outer plate surrounding said inner plate and oriented generally parallel to said inner plate; and,
a third component including a plurality of flexure links disposed between said inner plate and said outer plate, integrally connecting said inner plate to said outer plate,
said flexure links comprising strain rings operative to measure forces between said inner plate and said outer plate.

2. A force measuring device as recited in claim 1, wherein said strain ring comprises:
a generally annular shaped top surface;
a generally annular shaped bottom surface;
an inner surface extending between said top and said bottom surfaces, said inner surface defining a right circular cylinder;
an outer surface extending between said top and said bottom surfaces, said outer surface having a generally cylindrical shape;
a first interconnecting segment extending over a first portion of said outer surface, integrally connecting said strain ring with said inner plate; and,
a second interconnecting segment extending over a second portion of said outer surface, integrally connecting said strain ring with said outer plate.

3. A force measuring device as recited in claim 2, wherein at least one strain measuring device is attached to said inner surface.

4. A force measuring device as recited in claim 2, wherein at least one strain measuring device is attached to said top surface.

5. A force measuring device as recited in claim 2, wherein at least one strain measuring device is attached to said bottom surface.

6. A force measuring device as recited in claim 1, wherein three said flexure links are disposed between said inner and said outer plates.

7. A force measuring device as recited in claim 1, wherein four said flexure links are disposed between said inner and said outer plates.

8. A force measuring device as recited in claim 1, wherein said first, said second, and said third components are made from a single block of starting material.

9. A force measuring device having three integral components, comprising:
a first component including a rigid inner plate;
a second component including a rigid outer plate surrounding said inner plate and oriented generally parallel to said inner plate; and,
a third component including a plurality of strain rings disposed between said inner plate and said outer plate, integrally connecting said inner plate to said outer plate, and operative to measure forces between said inner plate and said outer plate, said strain rings comprising
a generally annular shaped top surface,
a generally annular shaped bottom surface,
an inner surface extending between said top and said bottom surfaces, said inner surface defining a right circular cylinder,
an outer surface extending between said top and said bottom surfaces, said outer surface having a generally cylindrical shape,
a first interconnecting segment extending over a first portion of said outer surface, integrally connecting said strain ring with said inner plate, and
a second interconnecting segment extending over a second portion of said outer surface, integrally connecting said strain ring with said outer plate.

10. A force measuring device as recited in claim 9, wherein at least one strain measuring device is attached to said inner surface.

11. A force measuring device as recited in claim 9, wherein at least one strain measuring device is attached to said top surface.

12. A force measuring device as recited in claim 9, wherein at least one strain measuring device is attached to said bottom surface.

13. A force measuring device as recited in claim 9, wherein said first, said second, and said third components are made from a single block of starting material.

14. A force measuring device having three integral components, comprising:
a first component including a rigid inner plate;
a second component including a rigid outer plate surrounding said inner plate and oriented generally parallel to said inner plate;
a third component including a plurality of strain rings disposed between said inner plate and said outer plate, integrally connecting said inner plate to said outer plate, and operative to measure forces between said inner plate and said outer plate, said strain rings comprising
a generally annular shaped top surface,
a generally annular shaped bottom surface,
an inner surface extending between said top and said bottom surfaces, said inner surface defining a right circular cylinder,
an outer surface extending between said top and said bottom surfaces, said outer surface having a generally cylindrical shape,
a first interconnecting segment extending over a first portion of said outer surface, integrally connecting said strain ring with said inner plate, and
a second interconnecting segment extending over a second portion of said outer surface, integrally connecting said strain ring with said outer plate;
wherein at least one strain measuring device is attached to said inner surface.

15. A force measuring device as recited in claim 14, wherein said first, said second, and said third components, are made from a single block of starting material.

16. A force measuring device having three integral components, comprising:
a first component including a rigid inner plate;
a second component including a rigid outer plate surrounding said inner plate and oriented generally parallel to said inner plate;
a third component including a plurality of strain rings disposed between said inner plate and said outer plate, integrally connecting said inner plate to said outer plate, and operative to measure forces between said inner plate and said outer plate, said strain rings comprising
a generally annular shaped top surface,
a generally annular shaped bottom surface,
an inner surface extending between said top and said bottom surfaces, said inner surface defining a right circular cylinder,
an outer surface extending between said top and said bottom surfaces, said outer surface having a generally cylindrical shape,
a first interconnecting segment extending over a first portion of said outer surface, integrally connecting said strain ring with said inner plate, and
a second interconnecting segment extending over a second portion of said outer surface, integrally connecting said strain ring with said outer plate;
wherein at least one strain measuring device is attached to said inner surface and at least one strain measuring device is attached to said top surface.

17. A force measuring device as recited in claim 16, wherein said first, said second, and said third components, are made from a single block of starting material.

18. A force measuring device having three integral components, comprising:
a first component including a rigid inner plate;
a second component including a rigid outer plate surrounding said inner plate and oriented generally parallel to said inner plate;
a third component including a plurality of strain rings disposed between said inner plate and said outer plate, integrally connecting said inner plate to said outer plate, and operative to measure forces between said inner plate and said outer plate, said strain rings comprising
a generally annular shaped top surface,
a generally annular shaped bottom surface,
an inner surface extending between said top and said bottom surfaces, said inner surface defining a right circular cylinder,
an outer surface extending between said top and said bottom surfaces, said outer surface having a generally cylindrical shape,
a first interconnecting segment extending over a first portion of said outer surface, integrally connecting said strain ring with said inner plate, and
a second interconnecting segment extending over a second portion of said outer surface, integrally connecting said strain ring with said outer plate;
wherein at least one strain measuring device is attached to said inner surface and at least one strain measuring device is attached to said bottom surface.

19. A force measuring device as recited in claim 18, wherein said first, said second, and said third components, are made from a single block of starting material.
